(19) United States
(12) Patent Application Publication
(10) Pub. No.: US 2015/0368070 A1
(43) Pub. Date: Dec. 24, 2015

(54) PLATFORM LIFT

(71) Applicants: Thomas A. Wesley, Big Bend, WI (US); Ronald J. Wesley, Big Bend, WI (US)

(72) Inventors: Thomas A. Wesley, Big Bend, WI (US); Ronald J. Wesley, Big Bend, WI (US)

(21) Appl. No.: 14/748,766

(22) Filed: Jun. 24, 2015

Related U.S. Application Data
(60) Provisional application No. 62/016,448, filed on Jun. 24, 2014.

(51) Int. Cl. B66B 9/08; B66B 9/02

(52) U.S. Cl. CPC B66B 9/0853; B66B 9/02

(57) ABSTRACT

A platform lift is provided. The platform lift includes a base frame and a platform. The base frame is configured to rest on a surface and support the platform lift in an upright position. The platform includes a substantially flat upper surface sized to support a wheel chair. The platform is substantially parallel with the base frame. A pivoting bracket attaches the base frame and the platform together. The present invention further includes an actuator operable to pivot the pivoting bracket thereby pivoting the platform from a surface level to an elevated position relative to the base frame.

### CROSS-REFERENCE TO RELATED APPLICATION

This application claims the benefit of priority of U.S. provisional application No. 62/016,448, filed Jun. 24, 2014, the contents of which are herein incorporated by reference.

### BACKGROUND OF THE INVENTION

The present invention relates to a wheelchair lift and, more particularly, to a platform lift to transport wheelchairs over stairs.

A wheelchair is a chair fitted with wheels. The device comes in variations allowing either manual propulsion by the seated occupant turning the rear wheels by hand, or electric propulsion by motors. There are often handles behind the seat to allow it to be pushed by another person. Wheelchairs are used by people for whom walking is difficult or impossible due to illness, injury, or disability.

Stairs are frequently needed at an entrance to a building. Therefore, the building must either be modified to include a ramp or a portable ramp must be used to accommodate for a wheelchair user.

As can be seen, there is a need for an improved device that helps wheelchair users enter buildings with a stairway.

### SUMMARY OF THE INVENTION

In one aspect of the present invention, a platform lift comprises: a base frame configured to rest on a surface and support the platform lift in an upright position; a platform comprising a substantially flat upper surface, the platform being substantially parallel with the base frame; a pivoting bracket attaching the base frame and the platform together; and an actuator operable to pivot the pivoting bracket, thereby pivoting the platform from a surface level to an elevated position relative to the base frame.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use in an exemplary initial configuration;

FIG. 2 is a perspective view of an embodiment of the present invention in an exemplary initial configuration;

FIG. 3 is a side view of an embodiment of the present invention in an exemplary initial configuration;

FIG. 4 is a perspective view of an embodiment of the present invention shown in use in transition between an initial and an elevated configuration;

FIG. 5 is a perspective view of an embodiment of the present invention in transition between an initial and an elevated configuration;

FIG. 6 is a side view of an embodiment of the present invention in transition between an initial and an elevated configuration;

FIG. 7 is a perspective view of an embodiment of the present invention shown in use in an exemplary elevated configuration;

FIG. 8 is a perspective view of an embodiment of the present invention in an exemplary elevated configuration;

FIG. 9 is a side view of an embodiment of the present invention in an exemplary elevated configuration; and

FIG. 10 is a bottom perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

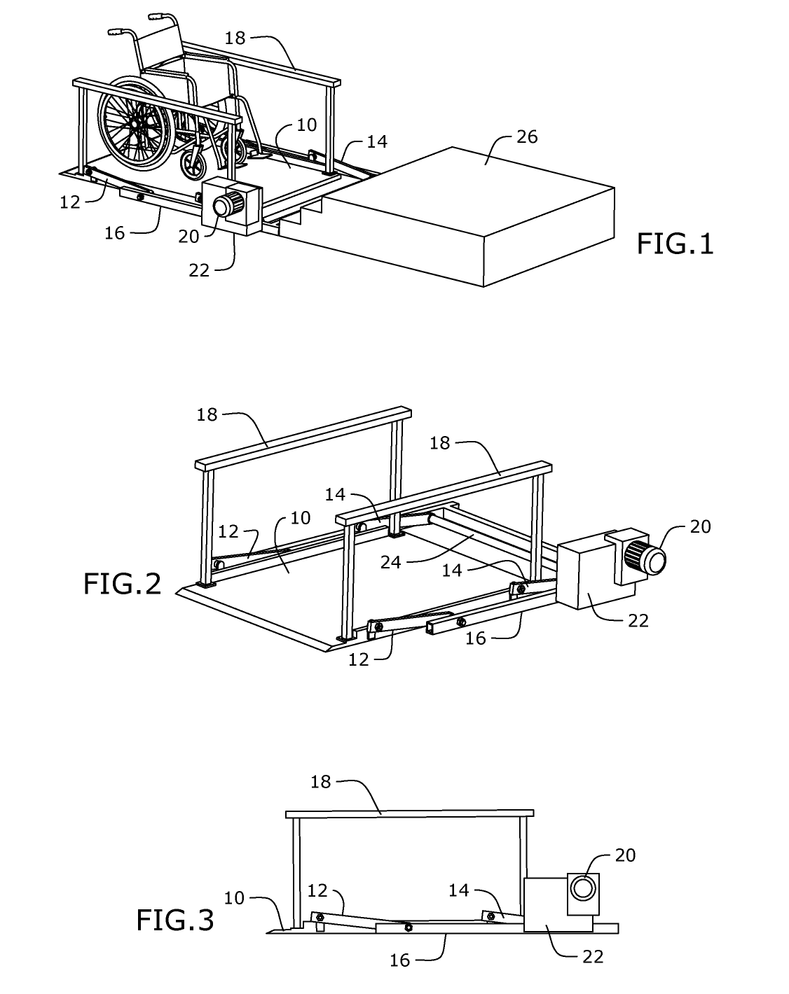

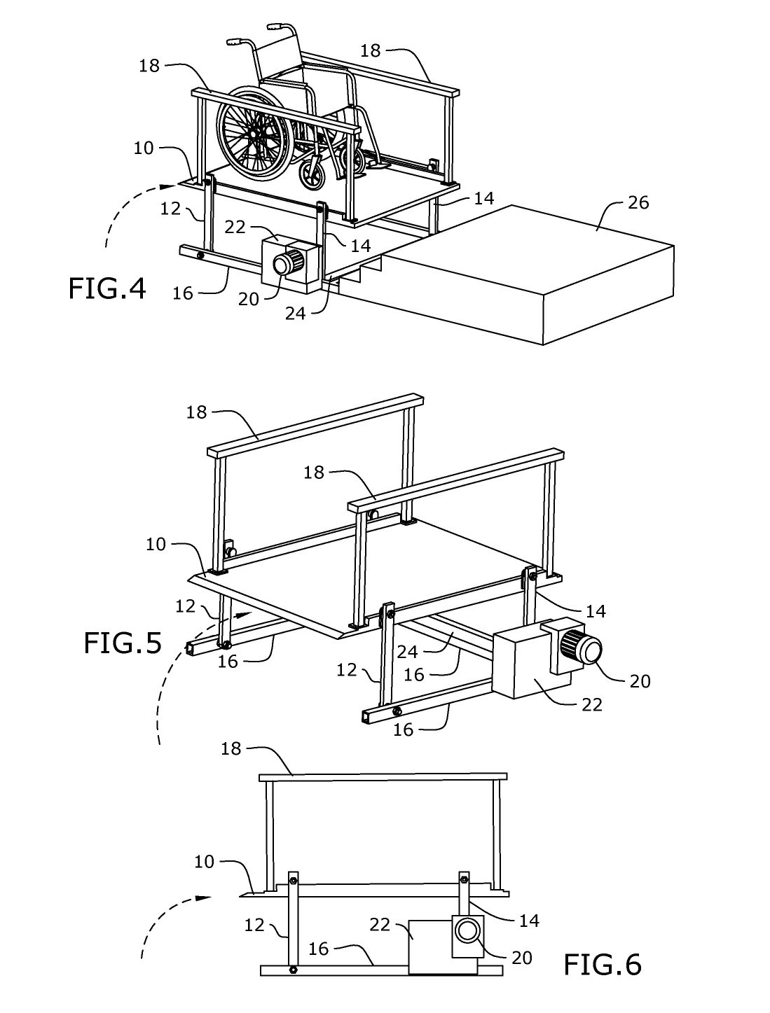

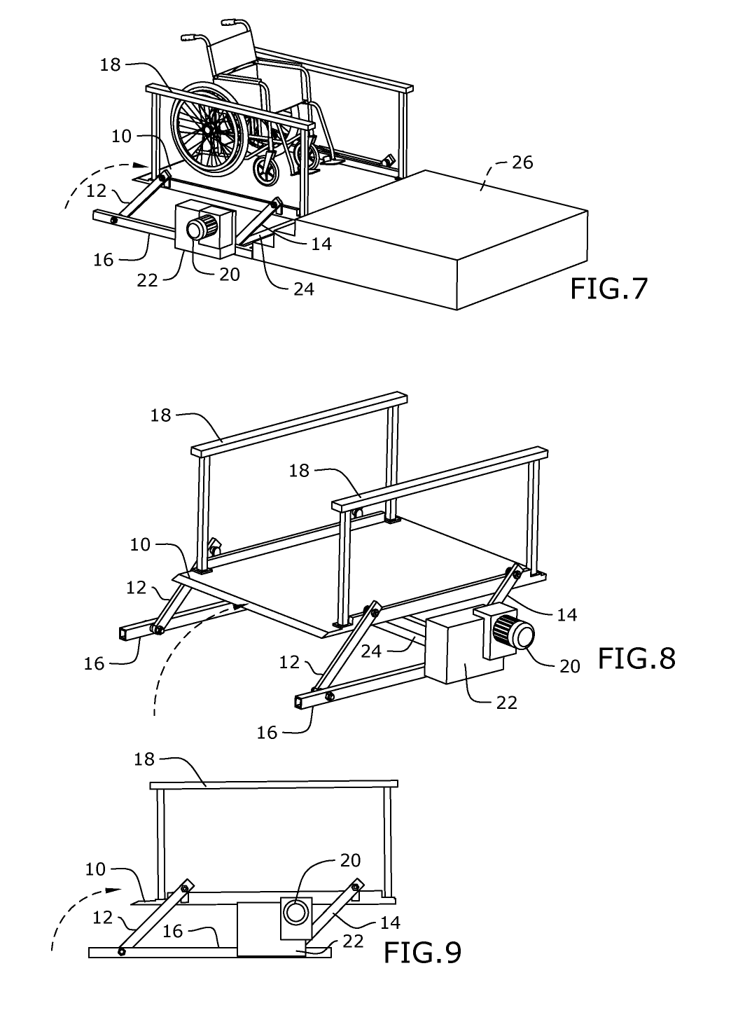

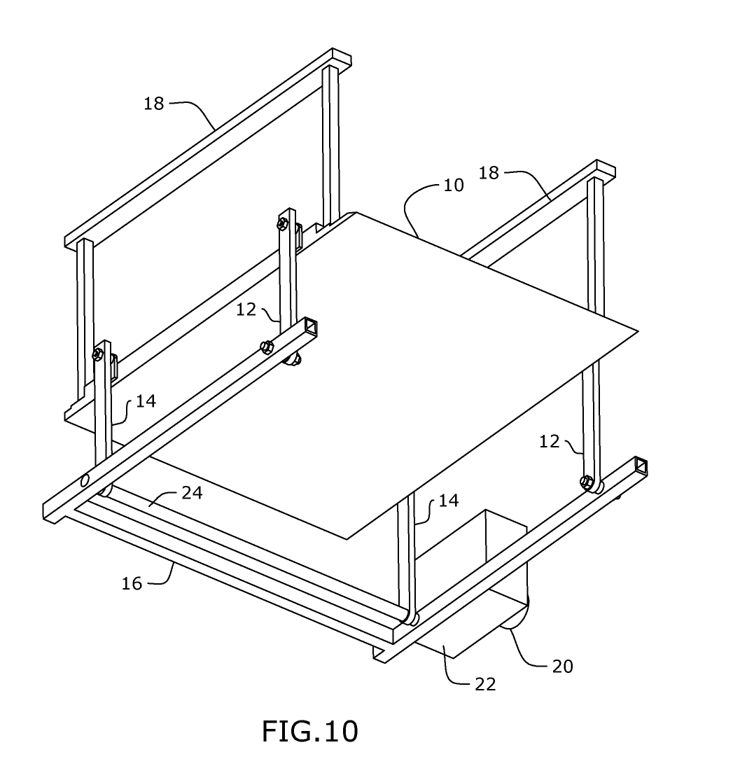

Referring to FIGS. 1 through 10, the present invention includes a platform lift. The platform lift includes a base frame 16 and a platform 10. The base frame 16 is configured to rest on a surface and support the platform lift in an upright position. The platform 10 includes a substantially flat upper surface sized to support a wheel chair. The platform 10 is substantially parallel with the base frame 16. A pivoting bracket 12, 14 attaches the base frame 16 and the platform 10 together. The present invention further includes an actuator 20, 22 operable to pivot the pivoting bracket 12, 14, thereby pivoting the platform 10 from a surface level to an elevated position relative to the base frame 16.

The base frame 16 may include two parallel side members, such as a first side member and a second side member. The base frame 16 may further include a cross member connecting the two side members together. The cross member may be positioned near a front end of the base frame 16. When the platform 10 is at the surface level, the platform 10 may be positioned in between the two side members and the cross member, and may thereby be level with the ground. This allows wheel chairs to easily mount onto the platform 10.

The pivoting bracket 12, 14 may include a plurality of pivoting arms. The plurality of pivoting arms may include a pair of front arms 14 and a pair of rear arms. Each of the front arms 14 and rear arms 14 may include a first end opposite a second end. The first ends may be pivotally connected to the side members of the base frame 16 and the second ends may be pivotally connected to mounts on the platform 10.

The actuator 20, 22 may include a gear box 22 driven by a motor 20. When the motor 20 is powered, the gears within the gear box 22 may rotate a rotating axel 24. The rotating axel 24 may pivotally connect the front legs 14 to the base 16. Therefore, the rotating axel 24 and the front legs 14 are fixed together, and the front legs 14 pivot with the rotation of the rotating axel 24. Since the rear legs 12 are pivotally connected to the base 16, the rear legs 12 pivot with the front legs 14 into the elevated position.

The present invention may include additional elements for making the power lift easier to use and safe. For example, the present invention may include a pair of hand rails 18 extending from the upper surface of the platform 10, allowing a user to pull themselves onto the platform 10 and stabilize themselves when the platform 10 moves from the surface level to the elevated position. Further, the present invention may include a beveled edge at the entrance, allowing the wheelchair to easily roll onto the platform 10.

When in use, the present invention may be placed in front of a stairway. The platform 10 may be positioned at surface or ground level. A user may roll onto the platform 10 over the beveled edge. The motor may be powered, thereby pivoting the pivoting bracket 12, 14 and lifting the platform 10 up to the elevated level. The pivoting bracket 12, 14 may pivot the platform 10 at least about 90 degrees, but less than about 180 degrees relative to the surface. Once the platform reaches an elevated surface 26 on top of the stairway, the motor 20 may be powered off and the platform 10 may stop pivoting. The user may then roll off of the platform 10 and onto the elevated surface 26. Different lengths of legs may be used to accommodate for different sized stairways. Further, the user may control the amount of pivoting to adjust to different elevated surface 26 levels.

It should be understood, of course, that the foregoing relates to exemplary embodiments of the invention and that modifications may be made without departing from the spirit and scope of the invention as set forth in the following claims.

What is claimed is:

1. A platform lift comprising:
a base frame configured to rest on a surface and support the platform lift in an upright position;
a platform comprising a substantially flat upper surface, the platform being substantially parallel with the base frame;
a pivoting bracket attaching the base frame and the platform together; and
an actuator operable to pivot the pivoting bracket, thereby pivoting the platform from a surface level to an elevated position relative to the base frame.

2. The platform lift of claim 1, wherein the pivoting bracket comprises a plurality of pivoting arms each comprising a first end pivotally connected to the base frame and a second end pivotally connected to the platform.

3. The platform lift of claim 2, wherein the plurality of pivoting arms comprises a pair of front arms and a pair of rear arms.

4. The platform lift of claim 3, wherein the actuator comprises a gear box driven by a motor, wherein the gear box is operatively connected to a rotating axel, wherein the rotating axel pivotally connects the second ends of the pair of front arms to the base frame.

5. The platform lift of claim 4, wherein the base frame comprise a first side member and a second side member, wherein the rotating axel transversely connects the first side member and the second side member.

6. The platform lift of claim 1, further comprising a pair of hand rails extending from the upper surface of the platform.

7. The platform lift of claim 1, wherein the platform comprises a beveled edge.

8. The platform lift of claim 1, wherein the pivoting bracket pivots at least about 90 degrees but less than about 180 degrees relative to the surface.
